(19) United States
(12) Patent Application Publication
(10) Pub. No.: US 2026/0370385 A1
(43) Pub. Date: Nov. 19, 2026

(54) AMBIENT INTERNET-OF-THINGS COMMAND PREAMBLE DIFFERENTIATION

(71) Applicant: QUALCOMM Incorporated, San Diego, CA (US)

(72) Inventors: Ahmed Abdelaziz Ibrahim Abdelaziz ZEWAIL, San Diego, CA (US); Zhifei FAN, San Diego, CA (US); Chengjin ZHANG, San Diego, CA (US)

(21) Appl. No.: 19/212,114

(22) Filed: May 19, 2025

(51) Int. Cl. H04L 1/08; H04L 1/00

(52) U.S. Cl. CPC H04L 1/08; H04L 1/0006

(57) ABSTRACT

In some aspects, an ambient internet-of-things (A-IoT) reader may transmit, to one or more A-IoT tags, a main command including a first preamble and one repetition identifier selected from a set of repetition identifiers. The A-IoT reader may transmit, to the one or more A-IoT tags, one or more follow-up commands, wherein each of the one or more follow-up commands has a second preamble different from the first preamble, and wherein each of the one or more follow-up commands is associated with one of the repetition identifiers in the set of repetition identifiers. The A-IoT reader may receive a response to the main command or a response to one of the one or more follow-up commands. Numerous other aspects are described.

### FIELD OF THE DISCLOSURE

Aspects of the present disclosure generally relate to ambient-internet-of-things (A-IoT) devices and, for example, to preambles for A-IoT command communications.

### BACKGROUND

Ambient internet-of-things (A-IoT) technology involves low-power tags that communicate with readers using wireless signals. A-IoT systems may be used in various environments, including warehouses, factories, and retail stores, to support applications such as inventory tracking, sensing, and control. Communications between A-IoT readers and tags may include energizing signals, command transmissions, and response signals. These interactions typically rely on preamble structures to indicate the beginning of a command and to help the receiving tag recognize and process the incoming data.

### SUMMARY

Some aspects described herein relate to an ambient internet-of-things (A-IoT) reader. The A-IoT reader may include a processing system. The processing system may include one or more processors and one or more code-storing memories coupled with the one or more processors. The processing system may be configured to cause the A-IoT reader to transmit, to one or more A-IoT tags, a main command including a first preamble and one repetition identifier selected from a set of repetition identifiers. The processing system may be configured to cause the A-IoT reader to transmit, to the one or more A-IoT tags, one or more follow-up commands, where each of the one or more follow-up commands has a second preamble different from the first preamble, and where each of the one or more follow-up commands is associated with one of the repetition identifiers in the set of repetition identifiers. The processing system may be configured to cause the A-IoT reader to receive a response to the main command or a response to one of the one or more follow-up commands.

Some aspects described herein relate to an A-IoT tag. The A-IoT tag may include a processing system. The processing system may include one or more processors and one or more code-storing memories coupled with the one or more processors. The processing system may be configured to cause the A-IoT tag to receive a main command with a first preamble and one repetition identifier selected from a set of repetition identifiers. The processing system may be configured to cause the A-IoT tag to receive one or more follow-up commands, where each of the one or more follow-up commands has a second preamble different from the first preamble, and where each of the one or more follow-up commands is associated with one of the repetition identifiers in the set of repetition identifiers. The processing system may be configured to cause the A-IoT tag to transmit, to an A-IoT reader, a response to the main command or a response to one of the one or more follow-up commands.

Some aspects described herein relate to a method of wireless communication performed by an A-IoT reader. The method may include transmitting, to one or more A-IoT tags, a main command including a first preamble and one repetition identifier selected from a set of repetition identifiers. The method may include transmitting, to the one or more A-IoT tags, one or more follow-up commands, where each of the one or more follow-up commands has a second preamble different from the first preamble, and where each of the one or more follow-up commands is associated with one of the repetition identifiers in the set of repetition identifiers. The method may include receiving, from at least one of the one or more A-IoT tags, a response to the main command or a response to one of the one or more follow-up commands.

Some aspects described herein relate to a method of wireless communication performed by an A-IoT tag. The method may include receiving, from an A-IoT reader, a main command with a first preamble and one repetition identifier selected from a set of repetition identifiers. The method may include receiving, from the A-IoT reader, one or more follow-up commands, where each of the one or more follow-up commands has a second preamble different from the first preamble, and where each of the one or more follow-up commands is associated with one of the repetition identifiers in the set of repetition identifiers. The method may include transmitting, to the A-IoT reader, a response to the main command or a response to one of the one or more follow-up commands.

Some aspects described herein relate to a non-transitory computer-readable medium that stores a set of instructions for wireless communication. The set of instructions, when executed by one or more processors of an A-IoT reader, may cause the A-IoT reader to transmit, to one or more A-IoT tags, a main command including a first preamble and one repetition identifier selected from a set of repetition identifiers. The set of instructions, when executed by one or more processors of the A-IoT reader, may cause the A-IoT reader to transmit, to the one or more A-IoT tags, one or more follow-up commands, where each of the one or more follow-up commands has a second preamble different from the first preamble, and where each of the one or more follow-up commands is associated with one of the repetition identifiers in the set of repetition identifiers. The set of instructions, when executed by one or more processors of the A-IoT reader, may cause the A-IoT reader to receive a response to the main command or a response to one of the one or more follow-up commands.

Some aspects described herein relate to a non-transitory computer-readable medium that stores a set of instructions for wireless communication by an A-IoT tag. The set of instructions, when executed by one or more processors of the A-IoT tag, may cause the A-IoT tag to receive a main command with a first preamble and one repetition identifier selected from a set of repetition identifiers. The set of instructions, when executed by one or more processors of the A-IoT tag, may cause the A-IoT tag to receive one or more follow-up commands. Each of the one or more follow-up commands has a second preamble different from the first preamble, and each of the one or more follow-up commands is associated with one of the repetition identifiers in the set of repetition identifiers. The set of instructions, when executed by one or more processors of the A-IoT tag, may cause the A-IoT tag to transmit, to the A-IoT reader, a response to the main command or a response to one of the one or more follow-up commands.

Some aspects described herein relate to an apparatus for wireless communication. The apparatus may include means for transmitting, to one or more A-IoT tags, a main command including a first preamble and one repetition identifier selected from a set of repetition identifiers. The apparatus may include means for transmitting, to the one or more A-IoT tags, one or more follow-up commands, where each of the one or more follow-up commands has a second preamble different from the first preamble, and where each of the one or more follow-up commands is associated with one of the repetition identifiers in the set of repetition identifiers. The apparatus may include means for receiving a response to the main command or a response to one of the one or more follow-up commands.

Some aspects described herein relate to an apparatus for wireless communication. The apparatus may include means for receiving a main command with a first preamble and one repetition identifier selected from a set of repetition identifiers. The apparatus may include means for receiving one or more follow-up commands, where each of the one or more follow-up commands has a second preamble different from the first preamble, and where each of the one or more follow-up commands is associated with one of the repetition identifiers in the set of repetition identifiers. The apparatus may include means for transmitting, to an A-IoT reader, a response to the main command or a response to one of the one or more follow-up commands.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example associated with wireless communication in an ambient internet-of-things (A-IoT) environment.

FIG. 2 is a diagram illustrating example components of a device.

FIG. 3 is a diagram illustrating an example sequence performed by an A-IoT device, such as an A-IoT tag.

FIGS. 4-5 are diagrams illustrating example cascaded preambles having a one or two-part format for preamble differentiation.

FIGS. 6-7 are diagrams illustrating example cascaded preamble receivers.

FIGS. 8-9 are flowcharts of example processes associated with A-IoT communication.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Warehouse management systems often use ambient internet-of-things (A-IoT) technology (e.g., radio frequency identification (RFID) devices) to manage inventory and track assets. For example, warehouse management systems may use RFID readers positioned at strategic chokepoints or gates within the warehouse to identify and process tagged items as the items pass through the chokepoints. While effective in certain scenarios, this model presents limitations in terms of continuous coverage and real-time tracking across the entire warehouse space. RFID readers positioned at chokepoints may not provide comprehensive coverage, potentially leaving blind spots where tagged items are not detected, and therefore, not accounted for in inventory management. Consequently, this approach can lead to inaccuracies in inventory records and inefficiencies in asset tracking operations.

In addition, RFID systems typically rely on a multi-step communication process for inventory management where a reader sends a query, and the tag responds with a unique identifier, followed by an acknowledgment from the reader and a final transmission of the tag's electronic product code (EPC). Such processes are subject to potential bottlenecks, especially in environments where numerous tags are present, leading to possible collisions and subsequent communication failures.

Moreover, the use of battery-free or energy-harvesting devices, which rely on ambient energy sources, introduces further challenges. These devices may operate in passive modes, making them susceptible to delays in response times due to slow energy harvesting rates. Consequently, devices may miss initial commands sent by readers, leading to incomplete inventory rounds and the need to continuously search for subsequent commands. This impacts the overall efficiency and accuracy of inventory processes.

Various aspects relate generally to enhancing inventory management in warehouse environments using an A-IoT system with continuous coverage. Some aspects more specifically relate to using multiple A-IoT readers to provide comprehensive coverage and enable efficient communication with A-IoT tags throughout a warehouse. In such systems, a central unit, referred to as a network commander, coordinates the operation of multiple readers. These readers can transmit main commands and follow-up commands to A-IoT tags, using different preambles for main commands and follow-up commands. The system allows each reader to operate in different modes based on scheduling decisions from the network commander, providing improved tracking and inventory processes.

In some aspects, the A-IoT system has one or more A-IoT readers that transmit a main command with a first preamble and a repetition identifier to the A-IoT tags, followed by one or more follow-up commands, each with a second preamble that is different from the first preamble. The follow-up commands are associated with repetition identifiers, allowing tags to respond only when a specific sequence of commands is received. This reduces processing overhead and prevents unnecessary decoding attempts, enhancing the efficiency of the communication process. The tags receive these commands and respond accordingly, ensuring that only relevant commands trigger a response, which optimizes energy usage and processing time.

Particular aspects of the subject matter described in this disclosure can be implemented to realize one or more of the following potential advantages. By using different preambles for main commands and for follow-up commands, the described techniques can be used to reduce false alarms and unnecessary processing in the tags, ensuring that tags only respond to relevant commands. In this way, the system conserves processing resources and energy consumption within the tags. Furthermore, by coordinating multiple readers through a network commander, the system provides comprehensive coverage, reducing blind spots and ensuring real-time inventory tracking across the entire warehouse. This reduces the likelihood of inaccuracies in inventory records and improves asset tracking operations, leading to more efficient warehouse management. By using repetition identifiers and distinct preamble sequences, the system minimizes communication collisions and enhances signal clarity, further improving the reliability of tag responses and overall system performance.

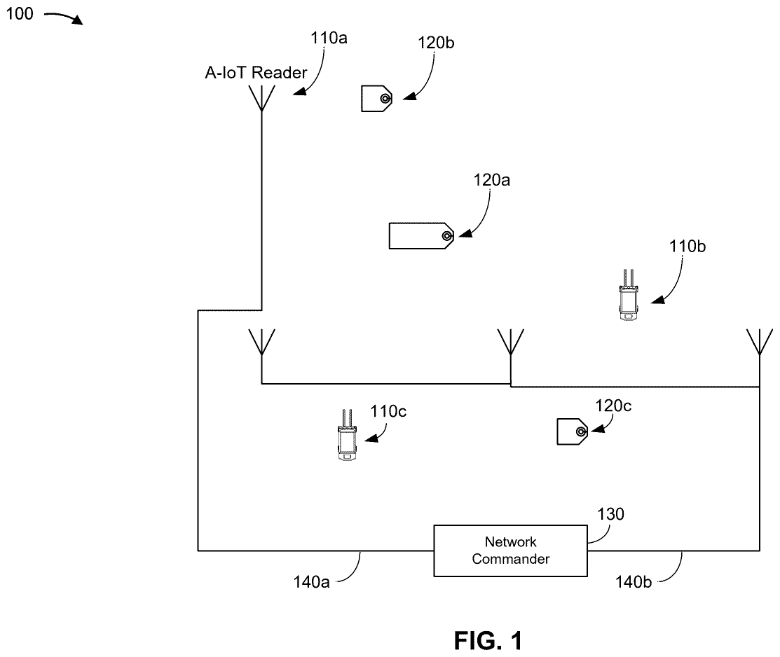

FIG. 1 is a diagram of an example associated with wireless communication in an A-IoT environment 100. In some aspects, the example may be associated with a warehouse environment. In some aspects, the A-IoT environment may include one or more A-IoT readers 110, one or more A-IoT tags 120, and a network commander 130, among other examples. For example, as shown by FIG. 1, one or more A-IoT readers (e.g., A-IoT readers 110a, 110b, and 110c) may each communicate with one or more A-IoT tags 120a, 120b, and 120c. In some aspects, the A-IoT readers 110 may transmit, to the one or more A-IoT tags 120, a main command. In some aspects, the main command may include a first preamble and one repetition identifier selected from a set of repetition identifiers. Accordingly, as discussed below, the A-IoT reader 110 may initiate communication with the A-IoT tags 120, and the main command may serve as a primary instruction (e.g., a query command) to the A-IoT tags 120.

In some aspects, the A-IoT reader 110 may periodically transmit synchronization signals to facilitate synchronization with the A-IoT tags 120. Periodic synchronization allows for the maintenance of communication integrity and helps ensure that the A-IoT tags 120 operate within expected parameters of the A-IoT system. Additionally, or alternatively, the A-IoT reader 110 may incorporate a priority-based command system, where critical inventory updates may be given precedence over routine asset tracking operations. With a priority-based command system, the A-IoT reader 110 may receive timely responses from the A-IoT tags 120 for high-priority tasks.

Additionally, as shown in FIG. 1, the network commander 130 may be configured to coordinate the operation of multiple A-IoT readers 110 within the A-IoT environment 100. In some aspects, the network commander 130 may dynamically allocate frequency channels among the A-IoT readers 110 to minimize interference and optimize the communication throughput in the A-IoT environment 100. Dynamic allocation of frequency channels may allow for adaptive management of network resources, enhancing overall system performance. Additionally, or alternatively, instead of using a centralized network commander 130, a distributed coordination mechanism may be implemented in the A-IoT environment 100. With a distributed coordination mechanism, each A-IoT reader 110 may autonomously select an operating mode in accordance with local conditions and activity of one or more other (e.g., neighboring) A-IoT readers 110. A distributed approach may further enable more flexible and resilient network operations, particularly in dynamic A-IoT environments such as a warehouse environment. Additionally, or alternatively, the network commander 130 may be configured to use one or more machine learning algorithms to predict optimal times and conditions for one or more operations of the A-IoT readers 110, thereby enhancing the efficiency and accuracy of the A-IoT devices within the A-IoT environment 100. In some aspects, machine learning may add a predictive capability, allowing for proactive adjustments to reader operations based on historical data and trends.

In some aspects, the network commander 130 may improve efficiency by allocating resources to the A-IoT readers 110 in a way that reduces interference. In some aspects, the network commander 130 may manage the A-IoT readers 110 via one or more backhaul links such as backhaul links 140a and 140b. Managing the A-IoT readers 110 via backhaul links 140 may provide continuous coverage and efficient inventory management in the A-IoT environment.

In some aspects, the A-IoT reader 110 may transmit one or more follow-up commands. In some aspects, each follow-up command may be transmitted with a second preamble. In some aspects, the second preamble is different from the first preamble included in the main commands. In some aspects, the second preamble may correspond to one of the repetition identifiers in the set. By using different preambles, the A-IoT readers 110 may distinguish command types which, as discussed below, may help the A-IoT tags 120 respond appropriately to the intended command sequence.

In some aspects, differentiating the preambles between the main commands and the follow-up commands may include applying additional identifiers indicating command priority levels, which the A-IoT tags 120 may use to prioritize their response actions. By incorporating command priority levels, the A-IoT system can effectively manage and prioritize A-IoT tag 120 responses according to the importance of the commands received. Additionally, or alternatively, the main command transmitted by the A-IoT reader 110 may include additional metadata, such as timestamp or location information, to provide context for the A-IoT tags 120 and to facilitate more precise tracking and reporting in the A-IoT environment 100. The inclusion of metadata enriches the command context, allowing for more accurate and informative A-IoT tag 120 responses. Additionally, or alternatively, the A-IoT tags 120 may be configured to enter a low-power listening mode by default and to activate fully only upon detecting the specific main command preamble, thereby extending their operational life in energy-constrained environments. In some aspects, the low-power listening mode may reduce energy consumption, leading to prolonged operational periods for the A-IoT tags 120, even in energy-limited scenarios.

As indicated above, FIG. 1 is provided as an example. Other examples may different from what is described with respect to FIG. 1.

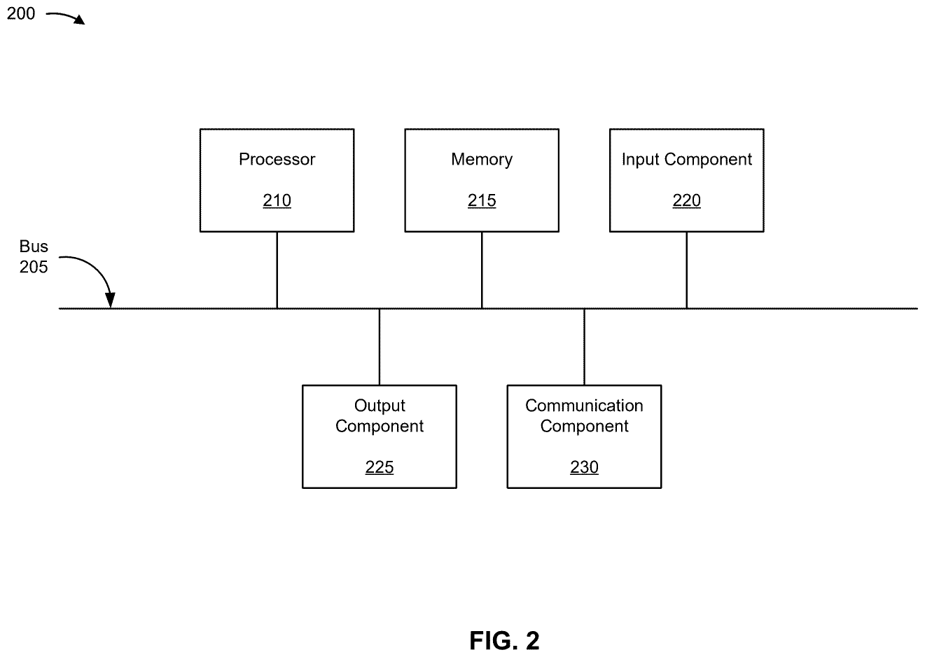

FIG. 2 is a diagram illustrating example components of a device 200. The device 200 may correspond to an A-IoT reader (e.g., A-IoT reader 110), an A-IoT tag (e.g., A-IoT tag 120), or a network commander (e.g., network commander 130), among other examples. As shown in FIG. 2, the device 200 may include a bus 205, a processor 210, a memory 215, an input component 220, an output component 225, or a communication component 230.

The bus 205 may include one or more components that enable wired or wireless communication among the components of the device 200. The bus 205 may couple together two or more components of FIG. 2, such as via operative coupling, communicative coupling, electronic coupling, or electric coupling. For example, the bus 205 may include an electrical connection (e.g., a wire, a trace, or a lead) or a wireless bus. The processor 210 may include a central processing unit, a graphics processing unit, a microprocessor, a controller, a microcontroller, a digital signal processor, a field-programmable gate array, an application-specific integrated circuit, or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile or nonvolatile memory. For example, the memory 215 may include random access memory (RAM), read only memory (ROM), a hard disk drive, or another type of memory (e.g., a flash memory, a magnetic memory, or an optical memory). The memory 215 may include internal memory (e.g., RAM, ROM, or a hard disk drive) or removable memory (e.g., removable via a universal serial bus connection). The memory 215 may be a non-transitory computer-readable medium. The memory 215 may store information, one or more instructions, or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read or process information stored in the memory 215 or to store information in the memory 215.

The input component 220 may enable the device 200 to receive input, such as user input or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, or an actuator. The output component 225 may enable the device 200 to provide output, such as via a display, a speaker, or a light-emitting diode. The communication component 230 may enable the device 200 to communicate with other devices via a wired connection or a wireless connection. For example, the communication component 230 may include a receiver, a transmitter, a transceiver, a modem, a network interface card, or an antenna.

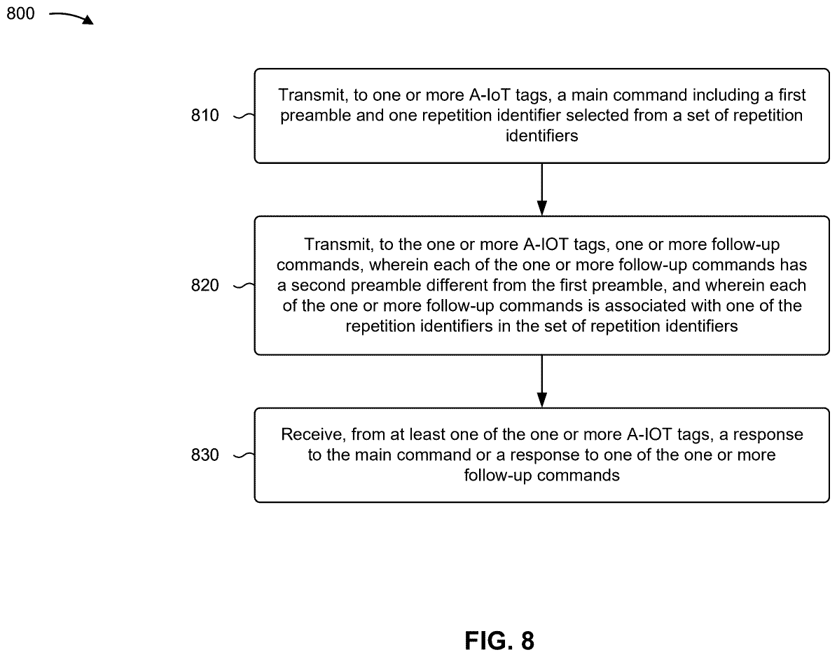

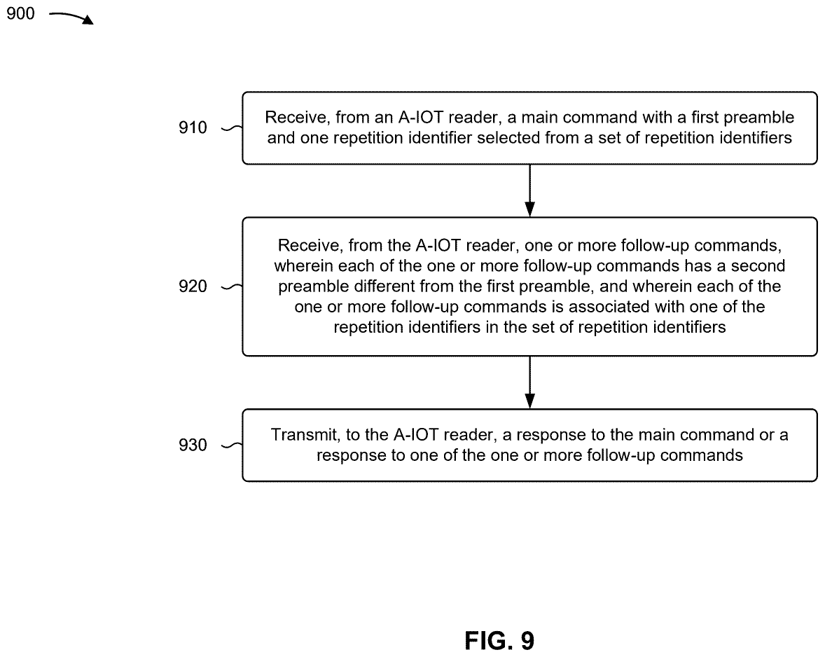

In some aspects, the device 200 may be configured to perform one or more operations described herein in connection with FIGS. 1 and 3-7. Additionally, or alternatively, the device 200 may be configured to perform one or more processes described herein, such as process 800 of FIG. 8, process 900 of FIG. 9, or a combination thereof. In some aspects, the device 200 or one or more components shown in FIG. 2 may include one or more components of the device described in connection with FIG. 1. Additionally, or alternatively, one or more components shown in FIG. 2 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The communication component 230 may receive communications, such as reference signals, control information, data communications, or a combination thereof. The communication component 230 may provide received communications to one or more other components of the device 200. In some aspects, the communication component 230 may perform signal processing on the received communications, and may provide the processed signals to the one or more other components of the device 200. In some aspects, the communication component 230 may include, for example, one or more of a radio, one or more radio frequency (RF) chains, one or more transceivers, or one or more modems, each of which may in turn be coupled with one or more antennas of the device 200. In some aspects, the communication component 230 transmit communications, such as reference signals, control information, data communications, or a combination thereof. In some aspects, one or more other components of the device 200 may generate communications and may provide the generated communications to the communication component 230 for transmission. In some aspects, the communication component 230 may perform signal processing on the generated communications, and may transmit the processed signals.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, the device 200 may include means for transmitting, to one or more A-IoT tags, a main command including a first preamble and one repetition identifier selected from a set of repetition identifiers; means for transmitting, to the one or more A-IoT tags, one or more follow-up commands, wherein each of the one or more follow-up commands has a second preamble different from the first preamble, and wherein each of the one or more follow-up commands is associated with one of the repetition identifiers in the set of repetition identifiers; and/or means for receiving, from at least one of the one or more A-IoT tags, a response to the main command or a response to one of the one or more follow-up commands. In some aspects, the device 200 may include means for receiving, from an A-IoT reader, a main command with a first preamble and one repetition identifier selected from a set of repetition identifiers; means for receiving, from the A-IoT reader, one or more follow-up commands, wherein each of the one or more follow-up commands has a second preamble different from the first preamble, and wherein each of the one or more follow-up commands is associated with one of the repetition identifiers in the set of repetition identifiers; and/or means for transmitting, to the A-IoT reader, a response to the main command or a response to one of the one or more follow-up commands. In some aspects, the means for device 200 to perform processes and/or operations described herein may include one or more components of device 200 described in connection with FIG. 2, such as bus 205, processor 210, memory 215, input component 220, output component 225, communication component 230, or a combination thereof, among other examples.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

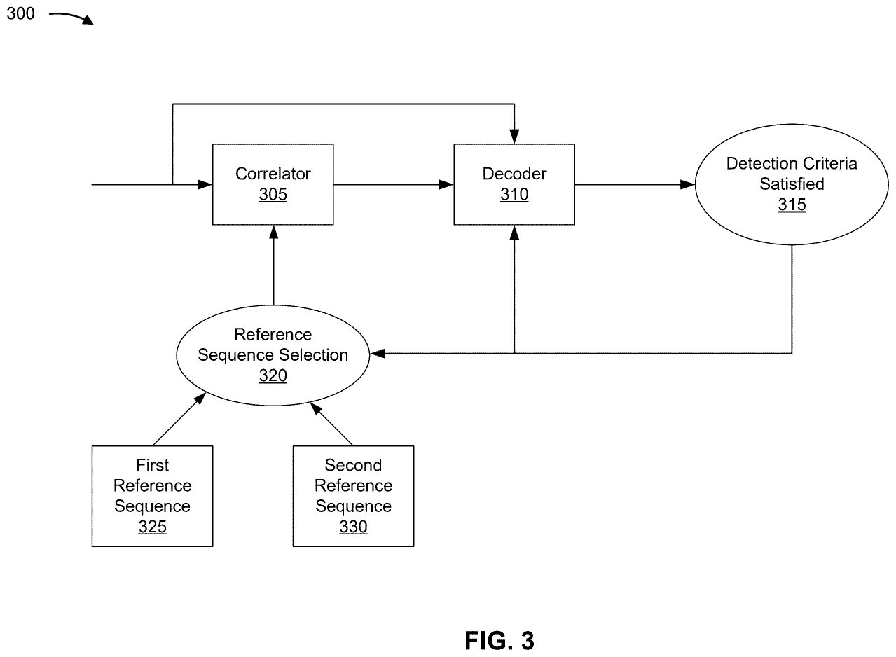

FIG. 3 is a diagram illustrating an example sequence 300 performed by an A-IoT device, such as an A-IoT tag (e.g., A-IoT tag 120). As shown in FIG. 3, the example sequence 300 includes a correlator block 305, a packet decoder block 310, a detection criteria block 315, a reference sequence selection block 320, a first reference sequence format block 325, and a second reference sequence format block 330.

In some aspects, the correlator block 305 may process a received sequence. In some aspects, the correlator block 305 may analyze incoming signals to identify specific patterns or signatures that correspond to known command sequences (e.g., a main command, a follow-up command, or a combination thereof, among other examples). In some aspects, the correlator block 305 may compare segments of incoming signals with stored templates.

The packet decoder block 310 may decode the received sequence. In some aspects, the packet decoder block 310 may perform error checking and correction to detect and rectify errors before received data is passed on to the detection criteria block 315. The packet decoder block 310 may interpret the data structure of the sequence, which may include extracting information necessary for subsequent processing steps.

The detection criteria block 315 may determine if a correlation satisfies (e.g., exceeds) a threshold, which may trigger further processing. Additionally, or alternatively, the detection criteria block 315 may evaluate a signal-to-noise ratio (SNR) or other quality metric to determine the integrity of the detected command sequence before proceeding.

The reference sequence selection block 320 may select between two or more reference sequence formats (e.g., a first reference sequence format 325 and a second reference sequence format 330, among other examples). In some aspects, the reference sequence selection block 320 may dynamically select a reference sequence format from among multiple reference sequence formats, which may include the first reference sequence format 325 and the second reference sequence format 330. In some aspects, the selection of the reference sequence format may depend on environmental factors or the specific operational mode of the A-IoT device. Additionally, or alternatively, the reference sequence selection block 320 may use a hierarchical selection process for reference sequence selection. The hierarchical selection process may include initially selecting between broad categories of formats and subsequently refining the selection to specific sub-formats based on additional criteria or historical data. In some aspects, the selection may occur in accordance with the outcome of the correlation process. For example, if the detection criteria are met, the A-IoT device may update the reference sequence, adapting its search mechanism to focus on the appropriate format for upcoming sequences. Additionally, or alternatively, the process of adapting the search mechanism may include a learning component where the A-IoT device optimizes its selection strategy over time based on past successful detections and processing outcomes. In doing so, the A-IoT device may efficiently transition between command types, optimizing response times and reducing processing load. Additionally, or alternatively, the A-IoT device may employ parallel processing techniques or predictive algorithms to preemptively prepare for predicted (e.g., likely) command sequences. The reference sequence formats may be stored in a database that the A-IoT device updates periodically based on firmware updates or user configurations, ensuring that the A-IoT device has access to the most relevant and recent reference sequences.

As indicated above, FIG. 3 is provided as an example. Other examples may different from what is described with respect to FIG. 3.

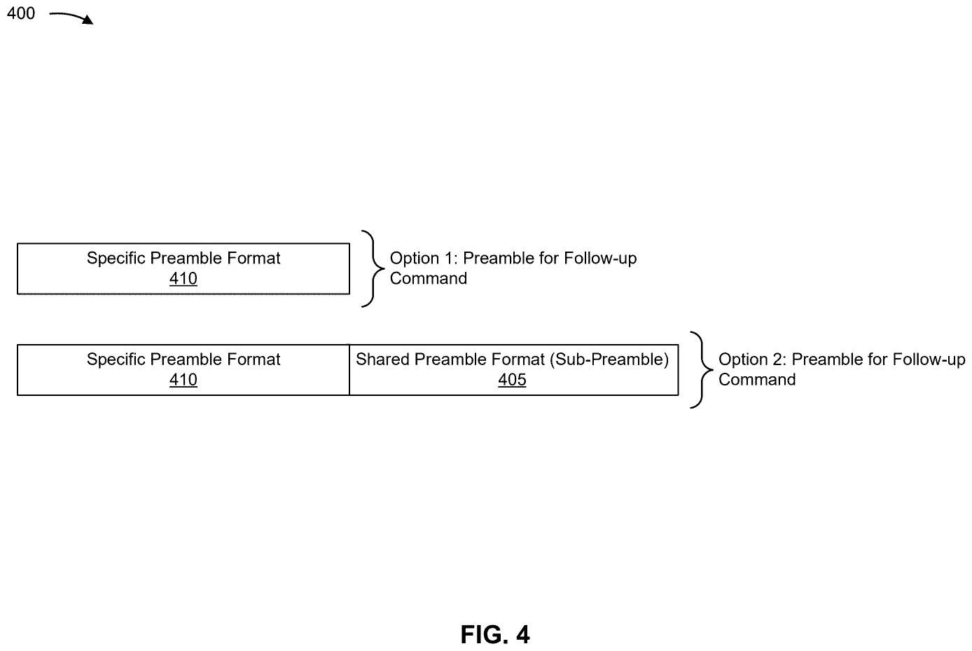

FIG. 4 is a diagram illustrating an example cascaded preamble 400 having a one-or two-part format for preamble differentiation. In some aspects, the cascaded preamble 400 may include a segmented preamble configuration. This configuration may involve multiple segments of bit sequences or sub-sequences, including a base segment (e.g., a shared part 405) and a unique identifier segment (e.g., a specific part 410). The base segment may serve as a reference point for all commands, while the unique identifier segment specifies whether a command is a main command or a follow-up command. Additionally, or alternatively, the cascaded preamble 400 may include an adaptive preamble design. This design may incorporate a dynamic segment that adjusts its properties based on the type of command. For example, the dynamic segment may alter its bit sequence or length depending on whether the dynamic segment is associated with a main command or a follow-up command. Additionally, or alternatively, the preamble may be structured in a dual-phase preamble structure. This structure may consist of two phases: a primary phase that identifies the command type and a secondary phase that provides command-specific details. The primary phase may include common identifiers, while the secondary phase may include unique identifiers for main and follow-up commands. In some aspects, the first part 405 is a preamble with a reference sequence format (e.g., the second reference sequence format 330 of FIG. 3). In some aspects, the second part 410 is a sub-preamble with a different reference sequence format (e.g., the first reference sequence format 325 of FIG. 3).

Preamble differentiation may be implemented within an A-IoT communication system to distinguish between main commands and follow-up commands through the use of the distinct preamble formats. For example, the shared part 405 may be common across multiple follow-up commands. Accordingly, the shared part 405 allows A-IoT tags (e.g., A-IoT tags 120) to initially recognize a command as being part of a follow-up sequence. In some aspects, the shared part 405 may include error-checking codes or parity bits to enhance the reliability of follow-up command recognition, thereby improving communication accuracy between the A-IoT reader (e.g., the A-IoT reader 110) and the A-IoT tags.

The specific part 410 may further distinguish specific commands within the sequence, particularly the main command from the follow-up commands. This differentiation aids in reducing processing requirements and potential false alarms by enabling the A-IoT tag to identify and prioritize the detection of the main command before processing follow-up commands. Additionally, or alternatively, the specific part 410 may include a unique frequency or modulation pattern that identifies the main command, allowing the receiver to prioritize decoding based on signal characteristics rather than sequence matching. A unique frequency or modulation pattern can provide a distinct signature that is easily identifiable by the A-IoT tags, enhancing the speed and accuracy of command recognition.

In some aspects, as shown in option 2 of FIG. 4, the preamble for follow-up commands may include the specific part 410, and a sub-preamble that includes a bit sequence or bit sub-sequence of the shared part 405.

As indicated above, FIG. 4 is provided as an example. Other examples may differ from what is described with regard to FIG. 4.

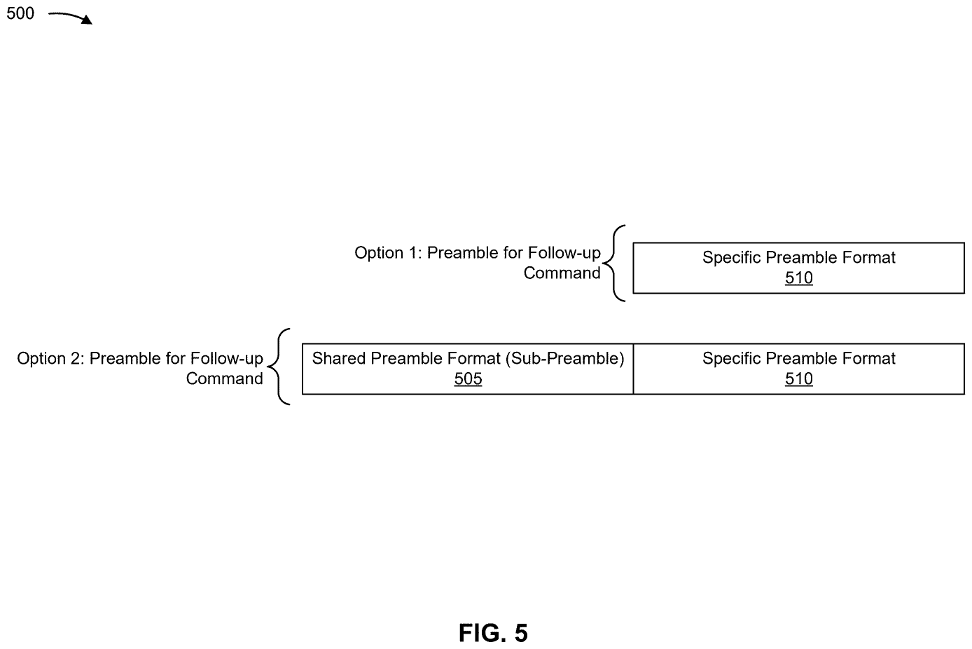

FIG. 5 is a diagram illustrating an example cascaded preamble 500 having a one or two-part format for preamble differentiation. For example, as shown in FIG. 5, the cascaded preamble 500 has a segmented preamble configuration (discussed above with respect to FIG. 4) that includes a shared part 505 and a specific part 510, each having a bit sequence. In some aspects, the shared part 505 is a preamble with a reference sequence format (e.g., the second reference sequence format 330 of FIG. 3). In some aspects, the specific part 510 is a sub-preamble with a different reference sequence format (e.g., the first reference sequence format 325 of FIG. 3).

In some aspects, the specific part 510 may identify, to the A-IoT tags (e.g., A-IoT tags 120), main commands, thereby aiding the A-IoT devices in distinguishing between initial and subsequent commands within the communication sequence. Accordingly, the configuration of the cascaded preamble 500 may prevent unnecessary processing by enabling A-IoT tags to properly distinguish main commands and follow-up commands. In some aspects, the specific part 510 may have one or more unique signal properties, such as frequency or modulation patterns, which allow for the prioritized decoding of main commands. Additionally, or alternatively, the specific part 510 may include a preamble with embedded control codes. Control codes may be embedded within the preamble to indicate the command sequence. For instance, control codes may signal the initiation of a new command sequence or the continuation of an existing sequence, facilitating seamless transitions between main commands and follow-up commands. Additionally, or alternatively, a frequency-division approach may be used for the preamble, whereby distinct frequency bands may be allocated for main commands and follow-up commands. This allocation may aid in the clear distinction and prioritization of command types within the A-IoT communication system. Additionally, or alternatively, differentiation between preamble formats may be achieved through modulation techniques. Main commands may use a specific modulation pattern distinct from follow-up commands, enhancing the efficiency of command recognition and processing. Additionally, or alternatively, the cascaded preamble 500 may incorporate advanced error-detection mechanisms to ensure accurate command recognition. This can involve the use of checksum or cyclic redundancy check (CRC) codes within the shared part 505 to improve reliability.

In the example cascaded preamble 500 of FIG. 5, the specific part 510 is positioned at the start of the cascaded preamble 500, serving as the initial segment that A-IoT tags encounter during preamble processing. Placing the specific part 510 at the beginning of the cascaded preamble 500 may cause the specific part 510 to act as a primary identifier for main commands, enabling A-IoT tags to quickly recognize and distinguish main commands from follow-up commands. By placing the specific part 510 at the beginning of the cascaded preamble 500, the A-IoT tag may distinguish main commands from follow-up commands early in the communication sequence, reducing the likelihood of false alarms and unnecessary processing. Accordingly, this arrangement improves the overall efficiency and accuracy of communication within the A-IoT environment.

In some aspects, as shown in option 2 of FIG. 5, the preamble for follow-up commands may include the specific part 510, and a sub-preamble that includes a bit sequence or bit sub-sequence of the shared part 505.

As indicated above, FIG. 5 is provided as an example. Other examples may differ from what is described with regard to FIG. 5.

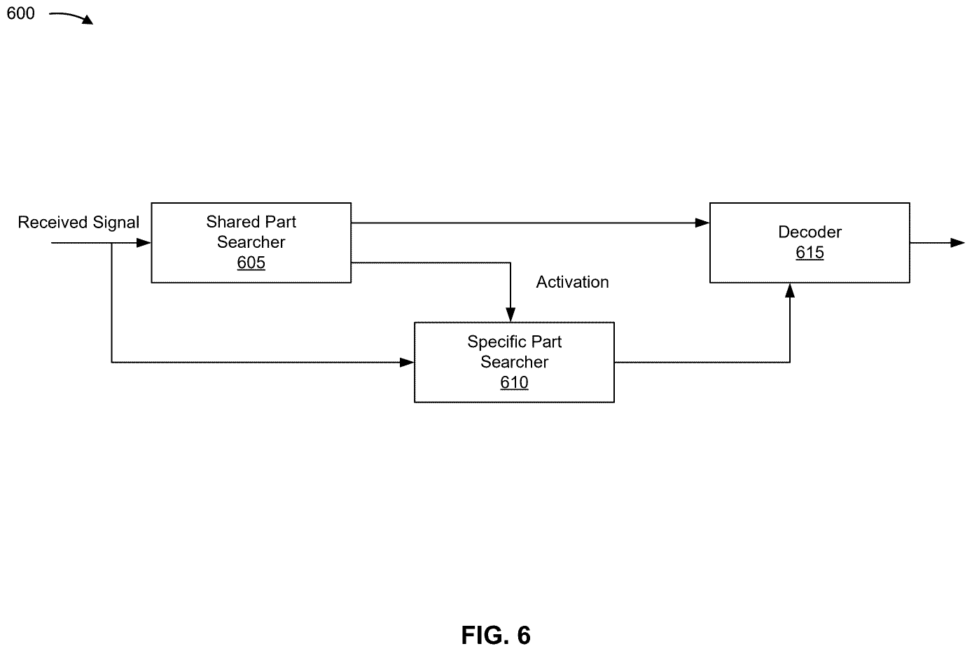

FIG. 6 is a diagram illustrating an example cascaded preamble receiver 600. In some aspects, the cascaded preamble receiver 600 may be included in each of the A-IoT tags (e.g., A-IoT tags 120). As shown in FIG. 6, the cascaded preamble receiver 600 includes a shared part searcher block 605, a specific part searcher block 610, and a decoder block 615. In some aspects, the cascaded preamble receiver 600 may process received signals using a two-step search operation. For example, the shared part searcher block 605 may initially process a received signal to identify a shared part (e.g., shared part 405) of a cascaded preamble (e.g., cascaded preamble 400 of FIG. 4) common to multiple command types (e.g., common to main commands and to follow-up commands). The shared part searcher block 605 may activate the next stage (e.g., the specific part searcher block 610) upon detecting the shared part of the cascaded preamble. The specific part searcher block 610 may be activated when the shared part searcher block 605 finds the shared part of the cascaded preamble. The specific part searcher block 610 may detect a specific part (e.g., specific part 410) of the cascaded preamble that distinguishes between main commands and follow-up commands. This dual-stage searching operation allows for efficient preamble detection, minimizing unnecessary processing and enhancing energy efficiency.

In some aspects, the specific part searcher block 610 may incorporate adaptive filtering techniques, which may allow the specific part searcher block 610 to activate searching criteria based on environmental conditions or historical data, thereby enhancing detection accuracy. For example, adaptive filtering may refine search parameters dynamically, improving the receiver's ability to accurately identify preamble segments under varying signal conditions. Additionally, or alternatively, rather than activating the specific part searcher block 610 only after detecting the shared segment, both searcher blocks may operate concurrently, providing immediate feedback on the presence of main or follow-up commands. This concurrent operation may expedite command processing by enabling simultaneous analysis of shared and specific preamble components.

The decoder block 615 may be configured to execute wakeup logic to decode the received command sequence once both the shared and specific parts of the preamble have been identified. This ensures that the receiver 600 only processes relevant command sequences, thereby conserving computational resources and improving overall system performance. In some aspects, the decoder block 615 may implement one or more machine learning algorithms that predict the likelihood of command sequences, optimizing wakeup logic and further improving energy efficiency. For example, machine learning algorithms may enhance the receiver's ability to anticipate command patterns, streamlining the decoding process for more efficient response generation. Additionally, or alternatively, the decoder block 615 may incorporate a hierarchical decision-making framework, prioritizing the processing of certain command sequences based on their relevance to specific system functions. The framework may optimize the receiver's performance by ensuring that critical commands are prioritized during processing.

In some aspects, the cascaded preamble receiver 600 may include an additional verification block that confirms preamble detection by cross-referencing received signals with a stored database of known preamble sequences, which increases reliability in command processing. In some aspects, other configurations of the cascaded preamble receiver 600 may use time-division multiplexing to separate command processing tasks, reducing the risk of interference and enhancing signal clarity. This approach may improve the receiver's ability to handle multiple commands simultaneously by allocating distinct time slots for each processing task.

Alternatively, in some aspects, the cascaded preamble receiver 600 may perform a single-step search operation to process the entire cascaded preamble in one step, reducing complexity and speeding up signal processing. For example, the single-step search operation may streamline the search process by eliminating the need for separate detection stages, thereby accelerating the identification of command sequences. Additionally, or alternatively, the shared part searcher block 605 may be replaced with a parallel searcher architecture that simultaneously processes multiple preamble types, allowing for faster detection and reduced latency in signal processing. The parallel architecture may enable the receiver to manage a higher volume of incoming signals by concurrently analyzing various preamble formats. Additionally, or alternatively, a dynamic allocation system may assign processing resources based on the priority of the signal, allowing for more efficient use of computational power. The dynamic allocation system may dynamically adjust resource allocations in real-time, optimizing the receiver's performance based on current signal conditions.

As indicated above, FIG. 6 is provided as an example. Other examples may differ from what is described with regard to FIG. 6.

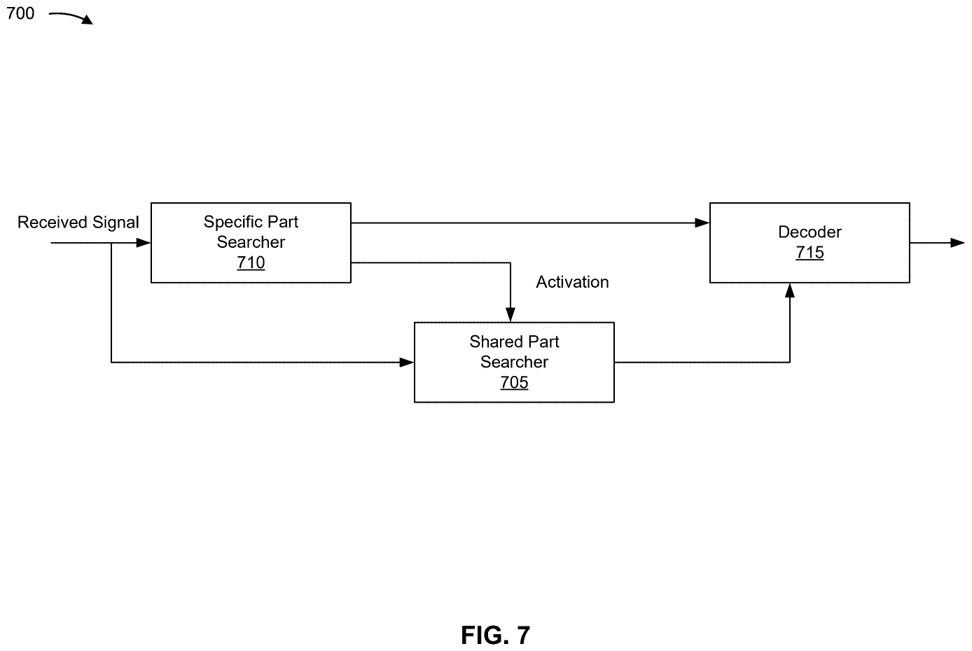

FIG. 7 is a diagram illustrating an example cascaded preamble receiver 700. In some aspects, the cascaded preamble receiver 700 may be included in each of the A-IoT tags (e.g., A-IoT tags 120). As shown in FIG. 7, the cascaded preamble receiver 700 includes a shared part searcher block 705, a specific part searcher block 710, and a decoder block 715. In some aspects, the cascaded preamble receiver 700 may process received signals using a two-step search operation. For example, the specific part searcher block 710 may initially process a received signal to identify a specific part (e.g., specific part 510) of a cascaded preamble (e.g., the cascaded preamble 500 of FIG. 5). The specific part searcher block 710 may activate the next stage (e.g., the shared part searcher block 705) upon detecting the specific part of the cascaded preamble. The shared part searcher block 705 may be activated when the specific part searcher block 710 finds the specific part of the cascaded preamble. The shared part searcher block 705 may detect a shared part (e.g., shared part 505) of the cascaded preamble that distinguishes between main commands and follow-up commands. This dual-stage searching operation allows for efficient preamble detection, minimizing unnecessary processing and enhancing energy efficiency.

In some aspects, the specific part searcher block 710 may incorporate adaptive filtering techniques, which may allow the specific part searcher block 710 to activate searching criteria based on environmental conditions or historical data, thereby enhancing detection accuracy. For example, adaptive filtering may refine search parameters dynamically, improving the receiver's ability to accurately identify preamble segments under varying signal conditions. Additionally, or alternatively, rather than activating the shared part searcher block 705 only after detecting the specific segment, both searcher blocks may operate concurrently, providing immediate feedback on the presence of main or follow-up commands. This concurrent operation may expedite command processing by enabling simultaneous analysis of shared and specific preamble components.

The decoder block 715 may be configured to execute wakeup logic to decode the received command sequence once both the shared and specific parts of the preamble have been identified. This ensures that the receiver 700 only processes relevant command sequences, thereby conserving computational resources and improving overall system performance. In some aspects, the decoder block 715 may implement one or more machine learning algorithms that predict the likelihood of command sequences, optimizing wakeup logic and further improving energy efficiency. For example, machine learning algorithms may enhance the receiver's ability to anticipate command patterns, streamlining the decoding process for more efficient response generation. Additionally, or alternatively, the decoder block 715 may incorporate a hierarchical decision-making framework, prioritizing the processing of certain command sequences based on their relevance to specific system functions. The framework may optimize the receiver's performance by ensuring that critical commands are prioritized during processing.

In some aspects, the cascaded preamble receiver 700 may include an additional verification block that confirms preamble detection by cross-referencing received signals with a stored database of known preamble sequences, which increases reliability in command processing. In some aspects, other configurations of the cascaded preamble receiver 700 may use time-division multiplexing to separate command processing tasks, reducing the risk of interference and enhancing signal clarity. This approach may improve the receiver's ability to handle multiple commands simultaneously by allocating distinct time slots for each processing task.

Alternatively, in some aspects, the cascaded preamble receiver 700 may perform a single-step search operation to process the entire cascaded preamble in one step, reducing complexity and speeding up signal processing. For example, the single-step search operation may streamline the search process by eliminating the need for separate detection stages, thereby accelerating the identification of command sequences. Additionally, or alternatively, the shared part searcher block 705 may be replaced with a parallel searcher architecture that simultaneously processes multiple preamble types, allowing for faster detection and reduced latency in signal processing. The parallel architecture may enable the receiver to manage a higher volume of incoming signals by concurrently analyzing various preamble formats. Additionally, or alternatively, a dynamic allocation system may assign processing resources based on the priority of the signal, allowing for more efficient use of computational power. The dynamic allocation system may dynamically adjust resource allocations in real-time, optimizing the receiver's performance based on current signal conditions.

As indicated above, FIG. 7 is provided as an example. Other examples may differ from what is described with regard to FIG. 7.

FIG. 8 is a flowchart of an example process 800 associated with A-IoT communication. In some aspects, one or more process blocks of FIG. 8 are performed by an A-IoT reader (e.g., A-IoT reader 110). In some aspects, one or more process blocks of FIG. 8 are performed by another device or a group of devices separate from or including the A-IoT reader, such as one or more components of device 200, such as processor 210, memory 215, input component 220, output component 225, communication component 230, or a combination thereof, among other examples.

As shown in FIG. 8, process 800 may include transmitting, to one or more A-IoT tags, a main command including a first preamble and one repetition identifier selected from a set of repetition identifiers (block 810). For example, the A-IoT reader may transmit, to one or more A-IoT tags, a main command including a first preamble and one repetition identifier selected from a set of repetition identifiers, as described above.

As further shown in FIG. 8, process 800 may include transmitting, to the one or more A-IoT tags, one or more follow-up commands, wherein each of the one or more follow-up commands has a second preamble different from the first preamble, and wherein each of the one or more follow-up commands is associated with one of the repetition identifiers in the set of repetition identifiers (block 820). For example, the A-IoT reader may transmit, to the one or more A-IoT tags, one or more follow-up commands, as described above. In some aspects, each of the one or more follow-up commands has a second preamble different from the first preamble. In some aspects, each of the one or more follow-up commands is associated with one of the repetition identifiers in the set of repetition identifiers.

As further shown in FIG. 8, process 800 may include receiving a response to the main command or a response to one of the one or more follow-up commands (block 830). For example, the A-IoT reader may receive a response to the main command or a response to one of the one or more follow-up commands, as described above.

Process 800 may include additional aspects, such as any single aspect or any combination of aspects described below and/or in connection with one or more other processes described elsewhere herein.

In a first aspect, process 800 includes selecting the one repetition identifier from the set of repetition identifiers.

In a second aspect, alone or in combination with the first aspect, the first preamble includes a first bit sequence and the second preamble includes a second bit sequence.

In a third aspect, alone or in combination with one or more of the first and second aspects, the first preamble includes a first bit sequence with a first bit length and the second preamble has a second bit sequence with a second bit length.

In a fourth aspect, alone or in combination with one or more of the first through third aspects, process 800 includes transmitting, to the one or more A-IoT tags, one or more control commands associated with configuring the one or more A-IoT tags with a first reference sequence format and a second reference sequence format.

In a fifth aspect, alone or in combination with one or more of the first through fourth aspects, the first reference sequence format is associated with the first preamble and the second reference sequence format is associated with the second preamble.

In a sixth aspect, alone or in combination with one or more of the first through fifth aspects, the first preamble includes a bit sequence of the second preamble.

Although FIG. 8 shows example blocks of process 800, in some aspects, process 800 includes additional blocks, fewer blocks, different blocks, or differently arranged blocks than those depicted in FIG. 8. Additionally, or alternatively, two or more of the blocks of process 800 may be performed in parallel.

FIG. 9 is a flowchart of an example process 900 associated with A-IoT communication. In some aspects, one or more process blocks of FIG. 9 are performed by an A-IoT tag (e.g., A-IoT tag 120). In some aspects, one or more process blocks of FIG. 9 are performed by another device or a group of devices separate from or including the A-IoT tag, such as one or more components of device 200, such as processor 210, memory 215, input component 220, output component 225, communication component 230, or a combination thereof, among other examples.

As shown in FIG. 9, process 900 may include receiving a main command with a first preamble and one repetition identifier selected from a set of repetition identifiers (block 910). For example, the A-IoT tag may receive a main command with a first preamble and one repetition identifier selected from a set of repetition identifiers, as described above.

As further shown in FIG. 9, process 900 may include receiving one or more follow-up commands, wherein each of the one or more follow-up commands has a second preamble different from the first preamble, and wherein each of the one or more follow-up commands is associated with one of the repetition identifiers in the set of repetition identifiers (block 920). For example, the A-IoT tag may receive one or more follow-up commands, as described above. In some aspects, each of the one or more follow-up commands has a second preamble different from the first preamble. In some aspects, each of the one or more follow-up commands is associated with one of the repetition identifiers in the set of repetition identifiers.

As further shown in FIG. 9, process 900 may include transmitting, to the A-IoT reader, a response to the main command or a response to one of the one or more follow-up commands (block 930). For example, the A-IoT tag may transmit, to the A-IoT reader, a response to the main command or a response to one of the one or more follow-up commands, as described above.

Process 900 may include additional aspects, such as any single aspect or any combination of aspects described below and/or in connection with one or more other processes described elsewhere herein.

In a first aspect, the first preamble includes a first bit sequence and the second preamble includes a second bit sequence.

In a second aspect, alone or in combination with the first aspect, the first preamble has a first bit sequence with a first bit length and the second preamble has a second bit sequence with a second bit length.

In a third aspect, alone or in combination with one or more of the first and second aspects, process 900 includes receiving, from the A-IoT reader, one or more control commands associated with configuring a first reference sequence format and a second reference sequence format.

In a fourth aspect, alone or in combination with one or more of the first through third aspects, the first reference sequence format is associated with the first preamble and the second reference sequence format is associated with the second preamble.

In a fifth aspect, alone or in combination with one or more of the first through fourth aspects, the first preamble includes a bit sequence of the second preamble.

In a sixth aspect, alone or in combination with one or more of the first through fifth aspects, process 900 includes detecting a first reference sequence in the first preamble.

In a seventh aspect, alone or in combination with one or more of the first through sixth aspects, process 900 includes detecting a second reference sequence in the second preamble.

In an eighth aspect, alone or in combination with one or more of the first through seventh aspects, process 900 includes operating in a low-power state, and transitioning to an active state as a result of detecting one or more of the first reference sequence or the second reference sequence.

In a ninth aspect, alone or in combination with one or more of the first through eighth aspects, process 900 includes selecting, for a reference sequence selection operation, a first reference sequence before receiving the main command, and selecting, for the reference sequence selection operation, a second reference sequence after receiving the main command.

In a tenth aspect, alone or in combination with one or more of the first through ninth aspects, process 900 includes decoding the main command in accordance with the first reference sequence.

In an eleventh aspect, alone or in combination with one or more of the first through tenth aspects, process 900 includes decoding one or more of the follow-up commands in accordance with the second reference sequence.

Although FIG. 9 shows example blocks of process 900, in some aspects, process 900 includes additional blocks, fewer blocks, different blocks, or differently arranged blocks than those depicted in FIG. 9. Additionally, or alternatively, two or more of the blocks of process 900 may be performed in parallel.

The following provides an overview of some Aspects of the present disclosure:
Aspect 1: A method of wireless communication performed by an A-IoT reader, comprising: transmitting, to one or more A-IoT tags, a main command including a first preamble and one repetition identifier selected from a set of repetition identifiers; transmitting, to the one or more A-IoT tags, one or more follow-up commands, wherein each of the one or more follow-up commands has a second preamble different from the first preamble, and wherein each of the one or more follow-up commands is associated with one of the repetition identifiers in the set of repetition identifiers; and receiving, from at least one of the one or more A-IoT tags, a response to the main command or a response to one of the one or more follow-up commands.
Aspect 2: The method of Aspect 1, further comprising selecting the one repetition identifier from the set of repetition identifiers.
Aspect 3: The method of any of Aspects 1-2, wherein the first preamble includes a first bit sequence and the second preamble includes a second bit sequence.
Aspect 4: The method of any of Aspects 1-3, wherein the first preamble includes a first bit sequence with a first bit length and the second preamble has a second bit sequence with a second bit length.
Aspect 5: The method of any of Aspects 1-4, further comprising transmitting, to the one or more A-IoT tags, one or more control commands associated with configuring the one or more A-IoT tags with a first reference sequence format and a second reference sequence format.
Aspect 6: The method of Aspect 5, wherein the first reference sequence format is associated with the first preamble and the second reference sequence format is associated with the second preamble.
Aspect 7: The method of any of Aspects 1-6, wherein the first preamble includes a bit sequence of the second preamble.
Aspect 8: The method of Aspect 7, wherein, in the first preamble, the bit sequence of the second preamble occurs before a bit sub-sequence associated with the first preamble.
Aspect 9: The method of Aspect 7, wherein, in the first preamble, the bit sequence of the second preamble occurs after a bit sub-sequence associated with the first preamble.
Aspect 10: A method of wireless communication performed by an A-IoT tag, comprising: receiving, from an A-IoT reader, a main command with a first preamble and one repetition identifier selected from a set of repetition identifiers; receiving, from the A-IoT reader, one or more follow-up commands, wherein each of the one or more follow-up commands has a second preamble different from the first preamble, and wherein each of the one or more follow-up commands is associated with one of the repetition identifiers in the set of repetition identifiers; and transmitting, to the A-IoT reader, a response to the main command or a response to one of the one or more follow-up commands.
Aspect 11: The method of Aspect 10, wherein the first preamble includes a first bit sequence and the second preamble includes a second bit sequence.
Aspect 12: The method of any of Aspects 10-11, wherein the first preamble has a first bit sequence with a first bit length and the second preamble has a second bit sequence with a second bit length.
Aspect 13: The method of any of Aspects 10-12, further comprising receiving, from the A-IoT reader, one or more control commands associated with configuring a first reference sequence format and a second reference sequence format.
Aspect 14: The method of Aspect 13, wherein the first reference sequence format is associated with the first preamble and the second reference sequence format is associated with the second preamble.
Aspect 15: The method of any of Aspects 10-14, wherein the first preamble includes a bit sequence of the second preamble.
Aspect 16: The method of Aspect 15, wherein, in the first preamble, the bit sequence of the second preamble occurs before a bit sub-sequence associated with the first preamble.
Aspect 17: The method of Aspect 15, wherein, in the first preamble, the bit sequence of the second preamble occurs after a bit sub-sequence associated with the first preamble.
Aspect 18: The method of any of Aspects 10-17, further comprising detecting a first reference sequence in the first preamble.
Aspect 19: The method of Aspect 18, further comprising detecting a second reference sequence in the second preamble.
Aspect 20: The method of Aspect 19, further comprising: operating in a low-power state; and transitioning to an active state as a result of detecting one or more of the first reference sequence or the second reference sequence.
Aspect 21: The method of any of Aspects 10-20, further comprising: selecting, for a reference sequence selection operation, a first reference sequence before receiving the main command; and selecting, for the reference sequence selection operation, a second reference sequence after receiving the main command.
Aspect 22: The method of Aspect 21, further comprising decoding the main command in accordance with the first reference sequence.
Aspect 23: The method of Aspect 21, further comprising decoding one or more of the follow-up commands in accordance with the second reference sequence.
Aspect 24: A system configured to perform one or more operations recited in one or more of Aspects 1-23.
Aspect 25: An apparatus comprising means for performing one or more operations recited in one or more of Aspects 1-23.
Aspect 26: A non-transitory computer-readable medium storing a set of instructions, the set of instructions comprising one or more instructions that, when executed by a device, cause the device to perform one or more operations recited in one or more of Aspects 1-23.
Aspect 27: A computer program product comprising instructions or code for executing one or more operations recited in one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, +a +b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An ambient internet-of-things (A-IoT) reader, comprising:
a processing system that includes one or more processors and one or more code-storing memories coupled with the one or more processors, the processing system configured to cause the A-IoT reader to:
transmit, to one or more A-IoT tags, a main command including a first preamble and one repetition identifier selected from a set of repetition identifiers;
transmit, to the one or more A-IoT tags, one or more follow-up commands,
wherein each of the one or more follow-up commands has a second preamble different from the first preamble, and
wherein each of the one or more follow-up commands is associated with one of the repetition identifiers in the set of repetition identifiers; and
receive a response to the main command or a response to one of the one or more follow-up commands.

2. The A-IoT reader of claim 1, wherein the processing system is configured to cause the A-IoT reader to select the one repetition identifier from the set of repetition identifiers.

3. The A-IoT reader of claim 1, wherein the first preamble includes a first bit sequence and the second preamble includes a second bit sequence.

4. The A-IoT reader of claim 1, wherein the first preamble includes a first bit sequence with a first bit length and the second preamble has a second bit sequence with a second bit length.

5. The A-IoT reader of claim 1, wherein the processing system is configured to cause the A-IoT reader to transmit, to the one or more A-IoT tags, one or more control commands associated with configuring the one or more A-IoT tags with a first reference sequence format and a second reference sequence format.

6. The A-IoT reader of claim 5, wherein the first reference sequence format is associated with the first preamble and the second reference sequence format is associated with the second preamble.

7. The A-IoT reader of claim 1, wherein the first preamble includes a bit sequence of the second preamble.

8. The A-IoT reader of claim 7, wherein, in the first preamble, the bit sequence of the second preamble occurs before a bit sub-sequence associated with the first preamble.

9. The A-IoT reader of claim 7, wherein, in the first preamble, the bit sequence of the second preamble occurs after a bit sub-sequence associated with the first preamble.

10. A method of wireless communication performed by an ambient internet-of-things (A-IoT) reader, comprising:
transmitting, to one or more A-IoT tags, a main command including a first preamble and one repetition identifier selected from a set of repetition identifiers;
transmitting, to the one or more A-IoT tags, one or more follow-up commands,
wherein each of the one or more follow-up commands has a second preamble different from the first preamble, and
wherein each of the one or more follow-up commands is associated with one of the repetition identifiers in the set of repetition identifiers; and
receiving, from at least one of the one or more A-IoT tags, a response to the main command or a response to one of the one or more follow-up commands.

11. The method of claim 10, further comprising selecting the one repetition identifier from the set of repetition identifiers.

12. The method of claim 10, wherein the first preamble includes a first bit sequence and the second preamble includes a second bit sequence.

13. The method of claim 10, wherein the first preamble includes a first bit sequence with a first bit length and the second preamble has a second bit sequence with a second bit length.

14. The method of claim 10, further comprising transmitting, to the one or more A-IoT tags, one or more control commands associated with configuring the one or more A-IoT tags with a first reference sequence format and a second reference sequence format.

15. The method of claim 14, wherein the first reference sequence format is associated with the first preamble and the second reference sequence format is associated with the second preamble.

16. The method of claim 10, wherein the first preamble includes a bit sequence of the second preamble.

17. The method of claim 16, wherein, in the first preamble, the bit sequence of the second preamble occurs before a bit sub-sequence associated with the first preamble.

18. The method of claim 16, wherein, in the first preamble, the bit sequence of the second preamble occurs after a bit sub-sequence associated with the first preamble.

19. A non-transitory computer-readable medium storing a set of instructions for wireless communication, the set of instructions comprising:
one or more instructions that, when executed by one or more processors of an ambient internet-of-things (A-IoT) reader, cause the A-IoT reader to:
transmit, to one or more A-IoT tags, a main command including a first preamble and one repetition identifier selected from a set of repetition identifiers;
transmit, to the one or more A-IoT tags, one or more follow-up commands,
wherein each of the one or more follow-up commands has a second preamble different from the first preamble, and
wherein each of the one or more follow-up commands is associated with one of the repetition identifiers in the set of repetition identifiers; and
receive a response to the main command or a response to one of the one or more follow-up commands.

20. The non-transitory computer-readable medium of claim 19, wherein the one or more instructions, when executed by the one or more processors of the A-IoT reader, cause the A-IoT reader to select the one repetition identifier from the set of repetition identifiers.
